(19) United States
(12) Patent Application Publication
(10) Pub. No.: US 2012/0203905 A1
(43) Pub. Date: Aug. 9, 2012

(54) M2M SERVCE PROVIDING SYSTEM, M2M TERMINAL, AND OPERATION METHODS THEREOF

(75) Inventors: Ki-Ho Lee, Gyeonggi-do (KR); Jong-Ho Park, Gyeonggi-do (KR)

(73) Assignee: KT Corporation

(21) Appl. No.: 13/367,588

(22) Filed: Feb. 7, 2012

(30) Foreign Application Priority Data
Feb. 7, 2011 (KR) 10-2011-0010695

(51) Int. Cl. G06F 15/173

(52) U.S. Cl. 709/225

(57) ABSTRACT

Provided are a machine to machine (M2M) service providing system, M2M terminals, and operation methods thereof. The M2M service providing system may include a location registration server and a M2M managing server. The location registration server may be configured to receive a location registration request from a M2M terminal and transmit a location registration response to the at least one M2M terminal, thereby allowing the at least one M2M terminal to access a mobile communication network. The M2M managing server may be configured to provide one of inactivation timer information and M2M server access period timer information in the M2M terminal according to a M2M service enrollment status of the M2M terminal.

### CROSS REFERENCE TO PRIOR APPLICATIONS

The present application claims priority under 35 U.S.C. §119 to Korean Patent Application No. 10-2011-0010695 (filed on Feb. 7, 2011), which is hereby incorporated by reference in its entirety.

### FIELD OF THE INVENTION

The present invention relates to a machine to machine (M2M) service providing system, a M2M terminal, and operation methods thereof.

### BACKGROUND OF THE INVENTION

Machine to machine (M2M) terminals may transmit a signal to a server through wired or wireless networks upon a certain event. An application program installed in the server may interpret or transform the signal into information for some predefined purpose. Such M2M terminals have been mounted on buses and taxies for various purposes, including collecting navigation information or broadcasting traffic information. In order for M2M terminals to communicate with a server or other M2M terminals, the M2M terminal may have a universal subscriber identity module (USIM) card registered with a communication network.

A USIM card, however, may not be registered for a communication network due to various reasons. For example, a user may not want to have M2M service. In this case, a user may not register a USIM card of a corresponding M2M terminal. Such M2M terminal with an unregistered USIM card for a communication network may be referred to as an unregistered M2M terminal. On the contrary, a M2M terminal with a USIM card registered for a communication network may be referred to as a registered M2M terminal.

Although a USIM card is not registered, a USIM card of a M2M terminal may repeatedly try to register at a communication network. Since many M2M terminals are generally installed on target objects at the same time, a M2M terminal may have a structure designed to have a USIM card turned on at all times and not to be individually controlled. A registration request of an unregistered M2M terminal may be denied from a corresponding communication network when the unregistered M2M terminal requests registration. Although the registration request is denied, the unregistered M2M terminal may continuously and regularly request registration to a corresponding communication network. Particularly, the unregistered M2M terminal may try to register whenever a type of a network is changed or a location area code (LAC) is changed. Accordingly, such an unregistered M2M terminal may generate unnecessary traffic in a network.

Such unnecessary traffic generated by unregistered M2M terminals may degrade an overall communication quality of a related network. Furthermore, such problem may become further serious because it is expected that demands of M2M services will be increased constantly, Accordingly, there is a need for developing a method for preventing unnecessary registration trial of unregistered M2M terminals.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, M2M terminals may be prevented from generating unnecessary signals.

In accordance with another aspect of the present invention, a registration request of an unregistered M2M terminal may be temporally granted in order to prevent generation of unnecessary registration trials.

In accordance with still another aspect of the present invention, M2M terminals unenrolled for a M2M service may be provided with inactivation timer information and restricted to access a wireless network until an inactivation timer is expired.

In accordance with an exemplary embodiment of the present invention, a system may be provided for providing a machine to machine (M2M) service. The system may include a location registration server and a M2M managing server. The location registration server may be configured to receive a location registration request from a M2M terminal and transmit a location registration response to the at least one M2M terminal, thereby allowing the at least one M2M terminal to access a mobile communication network. The M2M managing server may be configured to provide one of inactivation timer information and M2M server access period timer information to the M2M terminal according to a M2M service enrollment status of the M2M terminal.

The M2M terminal may include a universal subscriber identity module (USIM) card unregistered with the mobile communication network. In this case, the location registration unit may transmit a location registration response to the M2M terminal, thereby allowing access to the mobile communication network for a given time.

The M2M service enrollment status of the M2M terminal may be unenrolled for a M2M service. In this case, the location registration unit may transmit a location registration response to the M2M terminal, thereby allowing accessing the mobile communication network for a given time. Such a M2M terminal may access the M2M managing server for the given time and receive the inactivation timer information from the M2M managing server.

The M2M terminal may enable an inactivation timer based on the inactivation timer information and restricts access to the mobile communication network until the inactivation timer expires.

The M2M terminal may initiate an inactivation timer based on the inactivation timer information and restrict transmission of the location registration request to the location registration server until the inactivation timer expires.

The inactivation timer information may include an inactivation timer value.

The M2M service enrollment status of the M2M terminal may be enrolled for a M2M service, In this case, the M2M managing server may provide the M2M server access period timer information to the M2M terminal.

The M2M terminal may set up a M2M server access period timer based on the M2M server access period timer information. In this case, the M2M terminal may be allowed to access the mobile communication network until the M2M server access period timer is expired. Furthermore, the M2M terminal may receive the M2M service until the M2M server access period timer expires.

The M2M managing server may determine whether the at least one M2M terminal is enrolled for the M2M service after the M2M server access period timer expires.

The M2M server access period timer information may include a M2M server access period tinier value.

The inactivation timer information and the M2M server access period timer information may be initiated based on a type of at least one M2M terminal, a type of the M2M service, and a status of the mobile communication network.

In accordance with another exemplary embodiment of the present invention, a method may be for providing a machine to machine (M2M) service to a M2M terminal. The method may include transmitting a location registration response in response to a location registration request for allowing the M2M terminal to access a mobile communication network, and providing at least one of inactivation timer information and M2M server access period timer information to the M2M terminal according to a M2M service enrollment status of the M2M terminal.

In the transmitting a location registration response, the M2M terminal may be temporarily allowed to access the mobile communication network for a given time when the M2M terminal has a universal subscriber identity module (USIM) card unregistered with the mobile communication network.

In the transmitting a location registration response, the M2M terminal may be temporarily allowed to access the mobile communication network for a given time when the M2M terminal is not enrolled for a M2M service.

The method may further include, prior to providing at least one of inactivation timer information and M2M server access period timer information, determining whether the M2M terminal is enrolled for a M2M service based on subscribing information stored in a database.

The method may further include providing the inactivation timer information to the M2M terminal when the M2M service enrollment status of the M2M terminal is determined as unenrolled for the M2M service, initiating an inactivation timer based on the inactivation timer information, and restricting access of the M2M terminal to the mobile communication network until the inactivation timer expires.

The restricting access of the M2M terminal may include restricting transmission by the M2M terminal of a location registration request until the inactivation timer expires.

The method may further include providing the M2M server access period timer information to the M2M terminal when the M2M service enrollment status of the M2M terminal is determined as enrolled for the M2M service, initiating an M2M server access period timer based on the M2M server access period timer information, and allowing reception by the M2M terminal of the M2M service until the M2M server access period timer expires.

The method may further include repeating determining whether the M2M service enrollment status of the M2M terminal is enrolled for the M2M service after the M2M server access period timer expires.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a M2M service providing system in accordance with an exemplary embodiment of the present invention;

FIG. 2 illustrates a M2M terminal in accordance with an exemplary embodiment of the present invention;

FIG. 3 illustrates a M2M managing server in accordance with an exemplary embodiment of the present invention;

FIG. 4 illustrates an operation method of a M2M service providing system in accordance with an exemplary embodiment of the present invention;

FIG. 5 illustrates an operation method of an unenrolled M2M terminal in accordance with an embodiment of the present invention; and

FIG. 6 illustrates an operation method of an enrolled M2M terminal in accordance with an exemplary embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

For convenience and ease of understanding, a M2M service providing system in accordance with an exemplary embodiment of the present invention will be described as providing a M2M service through a 3^{rd} generation partnership project universal mobile telecommunication system (3GPP UMTS) network. The present invention, however, is not limited thereto. For example, a M2M service providing system may provide a M2M service through a global system for mobile communication (GSM) or through a long term evolution (LTE) advanced network in accordance with another embodiment.

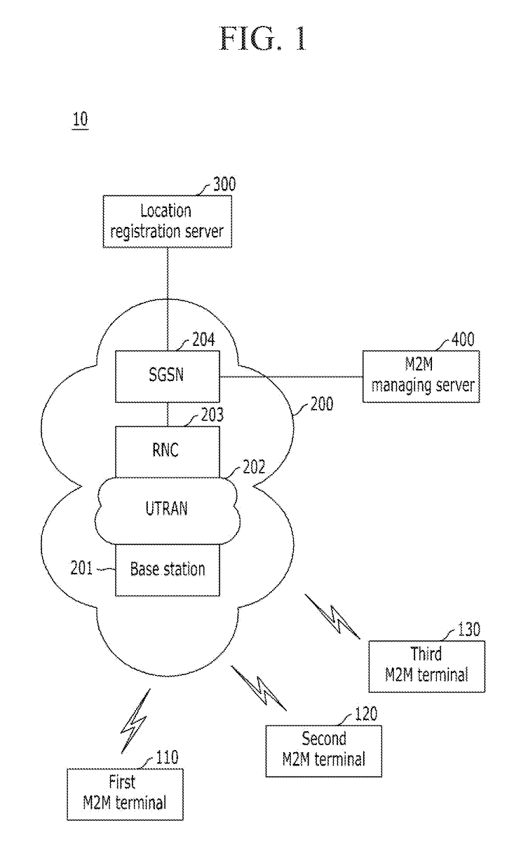

In accordance with an exemplary embodiment of the present invention, a M2M service providing system may reduce generation of unnecessary signal traffic. In order to reduce the generation of unnecessary signal traffic, an inactivation timer may be set up. The M2M service providing system may restrict a M2M terminal to access a network until the inactivation timer is expired. Hereinafter, the M2M service providing system will be described with reference to FIG. 1.

FIG. 1 illustrates a M2M service providing system in accordance with an exemplary embodiment of the present invention.

Referring to FIG. 1, M2M service providing system 10 in accordance with an embodiment of the present invention may include a plurality of M2M terminals 110 to 130, mobile communication network 200, location registration server 300, and M2M managing server 400. Mobile communication network 200 is illustrated as a universal mobile telecommunication system (UMTS) network in FIG. 1. The present invention, however, is not limited thereto. In accordance with another exemplary embodiment of the present invention, the mobile communication network 200 may be global system for mobile communication (GSM) or through a long term evolution (LIE) advanced network. Mobile communication network 200 may include base station 201, UNITS terrestrial radio access network (UTRAN) 202, radio network controller (RNC) 203, and serving general packet radio service (GPRS) support node (i.e., “SGSN”) 204.

M2M terminals 110 to 130 may each be a device associated with a corresponding M2M service. For example, M2M terminals 110 to 130 may be connected to M2M managing server 400 through mobile communication network 200. M2M terminals 110 to 130 may transmit one or more signals to each other and/or to M2M managing server 400. Furthermore, M2M terminals 110 to 130 may receive associated signals from other M2M terminals and/or from M2M managing server 400. M2M terminals 110 to 130 may exchange information with each other and/or with M2M managing server 400. M2M terminals 110 to 130 may be in a fixed or mobile configuration, and, if mobile, be mounted on a moving object such as, for example, buses, trains, or taxies. M2M terminals 110 to 130 may each include a universal subscriber identity module (USIM) card allowing for registration with a communication network.

M2M terminals 110 to 130 may be connected to mobile communication network 200. Particularly, M2M terminals 110 to 130 may access base station 201. Base station 210 may connect M2M terminals 110 to 130 via UTRAN 202. For example, base station 210 may be a Node B for UMTS radio (WCDMA or TD SCDMA) technology, or a Base Transceiver Station (BTS) if GSM radio technology is used. Base station 201 may convert a radio signal to a baseband signal. For example, base station 201 may receive a radio signal from at least one of M2M terminals 110 to 130, convert the radio signal to a baseband signal, and transmit the baseband signal to UTRAN 202. Furthermore, base station 201 may receive a baseband signal from UTRAN 202, convert baseband signal to a radio signal, and transmit the radio signal to the at least one of M2M terminals 110 to 130.

RNC 203 may connect UTRAN 202 with a UMTS core network node such as SGSN 204. RNC 230 may be a governing element in UTRAN 202 and control wireless resources. For example, RNC 203 may carry out radio resource management. RNC 203 may receive packets from at least one of M2M terminals 110 to 130 through UTRAN 202 and deliver the packets to SGSN 204. Base station 201 may transfer packets to SGSN 204 through RNC 203.

SGSN 204 may be any one of general packet radio service (GPRS) support nodes in the UMTS core network. SGSN 204 may authenticate a M2M terminal requesting a packet service through UTRAN 202. Furthermore, SGSN 204 may perform necessary operation for a packet call setup request. SGSN 204 may be connected to location registration server 300 and M2M managing server 400 in accordance with an exemplary embodiment of the present invention.

As shown in FIG. 1, location registration server 400 may be illustrated as an independent device. However, the present invention is not limited thereto. Location registration server 400 may be included in SGSN 204 as a location registration unit in accordance with another exemplary embodiment of the present invention.

Location registration server 300 may manage information on locations of M2M terminals 110 to 130. Location registration server 300 may receive a location registration request from at least one of M2M terminals 110 to 130 and transmit a location registration response to a corresponding one of M2M terminals 110 to 130 in response to the location registration request Location registration server 300 may grant a location registration request from M2M terminals 110 to 130 although USIM cards thereof are not necessarily registered for mobile communication network 200. For example, location registration server 300 may temporally allow M2M terminals 110 to 130 to access mobile communication network 200 for a limited time. The limited time may be a time enough for M2M terminals 110 to 130 exchanging necessary information with M2M managing server 400. Accordingly, M2M terminals 110 to 130 may not necessarily transmit unnecessary location registration request to location registration server 300 although one or more USIM cards of corresponding M2M terminals 110 to 130 are unregistered for mobile communication network 200.

M2M managing server 400 may be a device managing providing a M2M service. M2M managing server 400 may collect information on M2M terminals 110 to 130, analyze the collected M2M terminal information, and remotely control the M2M terminals 110 to 130 based on the analysis result.

For example, M2M managing server 400 may determine whether a M2M terminal is enrolled for a M2M service based on M2M service subscribing information of the M2M terminal after the location registration request of the M2M terminal is granted. When M2M managing server 400 determines that the M2M terminal is not enrolled for M2M service, M2M managing server 400 may transmit inactivation timer information to the M2M terminal. The inactivation timer information may be used to set up an inactivation timer. The inactivation timer information may include an inactivation timer value. The inactivation time value may be controlled based on a type of a terminal, a type of a M2M service, and a status of a corresponding network. The inactivation timer may be set up for restricting the unenrolled M2M terminal to try location registration. For example, M2M managing server 400 may restrict the unenrolled M2M terminal to access the UTRAN 200 until the inactivation timer is expired. Accordingly, the unenrolled M2M terminal may be prevented from regularly generating unnecessary signal for location registration.

Furthermore, when M2M managing server 400 determines that a M2M terminal is enrolled for a M2M service, M2M managing server 400 may transmit the M2M server access period timer information to M2M terminals 110 to 130. The M2M server access period timer information may be used to set up a M2M server access period timer. The M2M server access period timer information may include a M2M server access period timer value. The M2M server access period timer value may be controlled based on a type of a M2M terminal, a type of a M2M service, and a status of a corresponding network. The M2M terminal may be allowed to try location registration and/or to try to access M2M managing server until the M2M server access period timer is expired. Accordingly, the enrolled M2M terminal may be allowed to register its location or to access the M2M managing server only until the M2M server access period timer is expired.

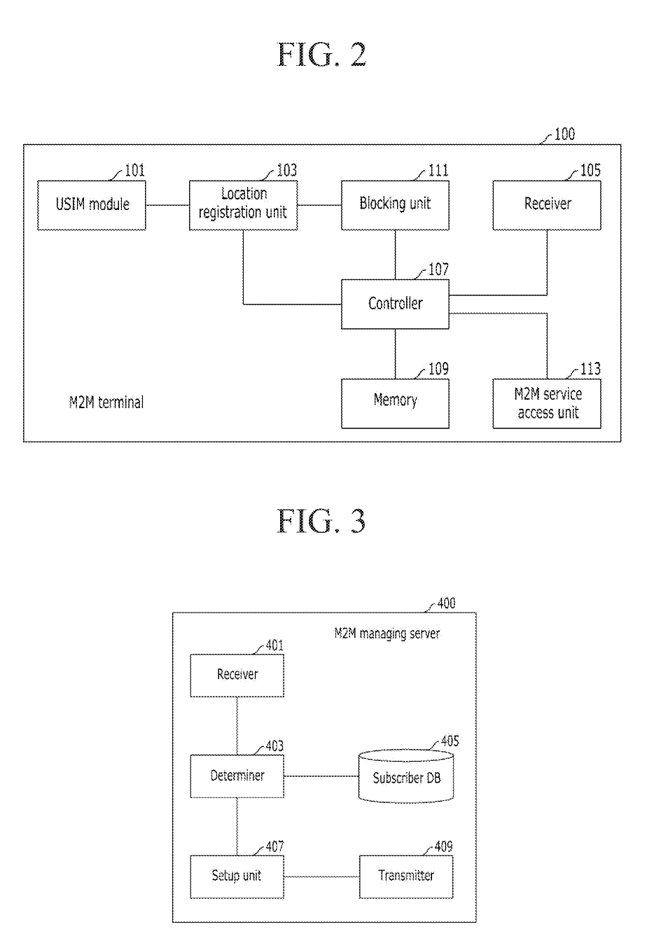

As described above, M2M terminals 110 to 130 may be allowed to access mobile communication network 200 although USIM cards thereof are not registered from mobile communication network 200 in accordance with an exemplary embodiment of the present invention. Furthermore, M2M terminals 110 to 130 may be restricted to access the mobile communication network 200 until the inactivation timer is expired when M2M terminals 110 to 130 are not enrolled for a M2M service. Accordingly, unnecessary signal generation may be prevented in accordance with an exemplary embodiment of the present invention. Hereinafter, such M2M terminals 110 to 130 will be described in detail with reference to FIG. 2.

FIG. 2 illustrates a M2M terminal in accordance with an exemplary embodiment of the present invention.

Referring to FIG. 2, M2M terminal 100 may include USIM module 101, location registration unit 103, receiver 105, controller 107, memory 109, blocking unit 111, and M2M service access unit 113.

USIM module 101 may be a card-shaped module that can be mounted in M2M terminal 100. USIM module 101 may include or otherwise contain personal information that might be provided under certain conditions to allow for various services, such as a user authentication service, a billing service, and a security service.

Location registration unit 103 may transmit a location registration request to UTRAN 200 based on the personal information stored in USIM module 101. In response to the location registration request, location registration unit 103 may receive a location registration response from UTRAN 200. Location registration unit 103 may perform location registration when the M2M terminal 100 is initially turned on or when a location of the M2M terminal 100 is changed. For example, location registration unit 103 may transmit a location registration request whenever a location area code (LAC) is changed.

Receiver 105 may receive the inactivation timer information or the M2M server access period timer information from M2M managing server 400. Receiver 105 may store the inactivation timer information and the M2M server access period timer information in memory 109.

Controller 107 may control the inactivation timer and the M2M server access period timer based on the received inactivation timer information and the M2M server access period timer information. Controller 107 may control overall operation of the M2M terminal 100 based on the inactivation timer and/or the M2M server access period timer. For example, controller 107 may set up the inactivation tinier based on the inactivation timer information received from M2M managing server 400. Then, controller 107 may start the inactivation timer and control blocking unit 111 based on the inactivation timer. Blocking unit 111 may restrict M2M terminal 100 from transmitting a location registration request and/or accessing mobile communication network 200 until the inactivation timer expires.

Furthermore, controller 107 may set up the M2M server access period timer based on the received M2M server access period timer information from M2M managing server 400. Then, controller 107 may start the M2M server access period timer. Controller 107 may request operation of M2M service access unit 113 until the M2M server access timer expires.

Blocking unit 111 may restrict M2M terminal 100 from accessing mobile communication network 200 until the inactivation timer expires. Accordingly, M2M terminal 100 desirably disables transmission of a location registration request until the inactivation timer expires. M2M service access unit 113 may transmit and receive M2M service packets to/from M2M managing server 500 until the M2M server access period timer expires.

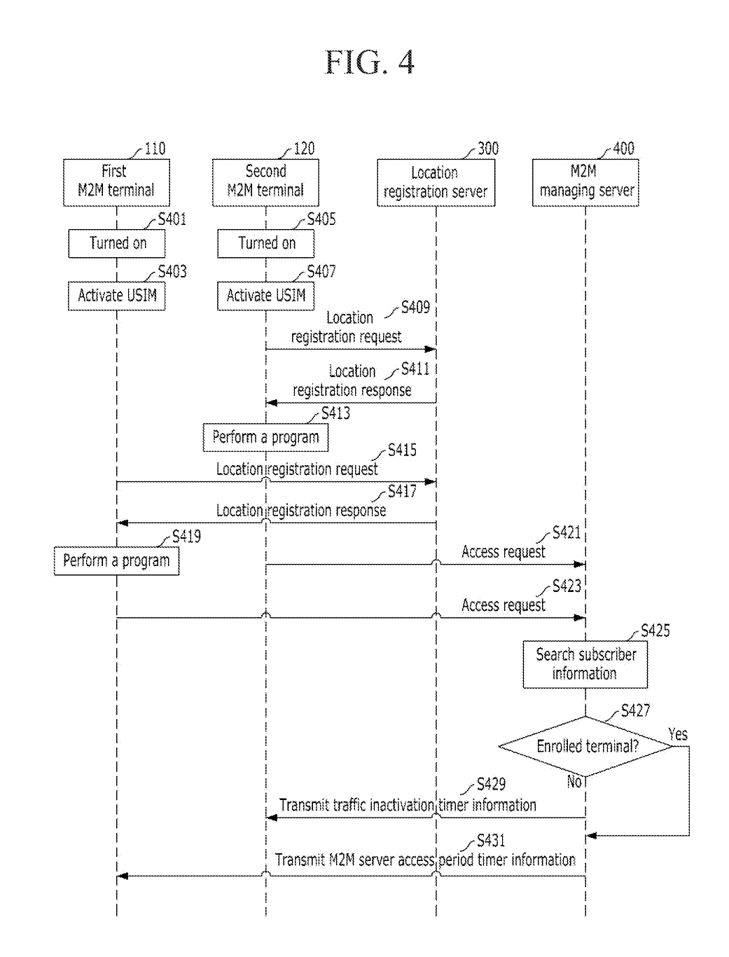

In accordance with an exemplary embodiment of the present invention, M2M managing server 400 may determine whether M2M terminal 100 is enrolled for a M2M service or not. According to the determination result, M2M managing server 400 may provide inactivation timer information or M2M server access period time information to M2M terminal 100. Hereinafter, such M2M managing server 400 will be described in detail with reference to FIG. 3.

FIG. 3 illustrates a M2M managing server in accordance with an exemplary embodiment of the present invention.

Referring to FIG. 3, M2M managing server 400 may include receiver 401, determiner 403, subscriber database (DB) 405, setup unit 407, and transmitter 409.

Receiver 401 may receive a M2M server access request from M2M terminal 100 after M2M terminal 100 grants location registration.

Subscriber DB 405 may store M2M service subscribing information. M2M service subscribing information may include information on a respective M2M terminal is enrolled for a M2M service or not.

Determiner 403 may search subscriber DB 405 and determine whether M2M terminal 100 is an enrolled M2M terminal or an unenrolled M2M terminal for M2M service based on the search result.

Setup unit 407 may set up inactivation timer information when M2M terminal 100 is determined as the unenrolled M2M terminal based on the determination result of determiner 403. Furthermore, setup unit 407 may set up M2M server access period timer information when M2M terminal 100 is the enrolled M2M terminal. For example, setup unit 407 may dynamically set up an inactivation timer value and a M2M server access period timer value based on at least one of following information: a type of the M2M terminal 100, a network status, and a type of a M2M service.

Transmitter 409 may transmit the inactivation timer information to the unenrolled M2M terminal. Alternatively, transmitter 409 may transmit the M2M server access period timer information to the enrolled M2M terminal.

As described above, M2M service providing system 10 may temporally grant a location registration request of a M2M terminal although the M2M terminal has a USIM card not registered for a communication network. In this manner, unnecessary registration trials or attempts of one or more unregistered M2M terminals may be prevented in accordance with an exemplary embodiment of the present invention. After temporary approval of the location registration request, a M2M terminal may be allowed to access a wireless network for a limited time. For example, the M2M terminal may be allowed to access a wireless network for a limited time period that is at least sufficient for accessing M2M managing server 400 and exchanging necessary information with M2M managing server 400. Particularly, M2M terminal 100 may receive an inactivation timer value from M2M managing server 400 during this limited period. M2M terminal 100 may be restricted to access a wireless network until an inactivation timer value is expired. Accordingly, M2M terminal 100 may be prevented to generate unnecessary signal traffic in a network in accordance with an exemplary embodiment of the present invention. Hereinafter, an operation method of a M2M service providing system in accordance with an exemplary embodiment of the present invention will be described with reference to FIG. 4.

FIG. 4 illustrates an operation method of a M2M service providing system in accordance with an exemplary embodiment of the present invention. Particularly, FIG. 4 illustrates a method of a M2M service providing system, which restricts M2M terminals to access a mobile communication network based on an enrollment status thereof in accordance with an exemplary embodiment of the present invention.

Referring to FIG. 4, M2M service providing system 10 may include enrolled M2M terminal 110, unenrolled M2M terminal 120, location registration server 300, and M2M managing server 400. Enrolled M2M terminal 110 may be referred to as a M2M terminal enrolled for a M2M service. Unenrolled M2M terminal 120 may be referred to as a M2M terminal unenrolled for a M2M service.

When enrolled M2M terminal 110 is powered on at step S401, a USIM card thereof may be activated at step S403. Similarly, when unenrolled M2M terminal 120 is powered on at step S405, a USIM card thereof may be activated at step S407.

Unenrolled M2M terminal 120 may try to register at a corresponding wireless communication network at step S409. For example, unenrolled M2M terminal 120 may transmit a location registration request to location registration server 300 based on information stored in the activated USIM card of unenrolled M2M terminal 120 in response to the location registration request, location registration server 300 may temporally allow (or deny, though a denial might restart or otherwise modify the method) unenrolled M2M terminal 120 to access a corresponding wireless network for a limited time at step S411. Although unenrolled M2M terminal 120 is an unregistered M2M terminal, location registration server 300 may temporally allow unenrolled M2M terminal 120 to access a corresponding wireless network for a limited time. The unregistered M2M terminal may be referred to a terminal with a USIM card not registered for a corresponding communication network, Location registration server 300 may transmit a location registration response to unenrolled M2M terminal 120 for allowing unenrolled M2M terminal 120 to access a corresponding wireless network. Accordingly, unenrolled M2M terminal 120 may communicate with M2M managing server 400 for the limited time. The limited time may be a time enough for unenrolled M2M terminal to exchange necessary information with M2M managing server 400. For example, the necessary information may be inactivation timer information.

Upon the receipt of the location registration response, unenrolled M2M terminal 120 may perform a program associated with a M2M service at step S413. For example, controller 107 (of, for example, FIG. 2) of unenrolled M2M terminal 120 may execute the program. Such a program may be stored in memory 109 (of, for example, FIG. 2), or downloaded from M2M managing server 400.

Enrolled M2M terminal 110 may also try to register at a corresponding wireless communication network at step S415. For example, enrolled M2M terminal 120 may transmit a location registration request to location registration server 300 based on information stored in the activated USIM card of enrolled M2M terminal 110. In response to the location registration request, location registration server 300 may allow (or deny, though a denial might restart or otherwise modify the method) enrolled M2M terminal 110 to access a corresponding wireless network at step S417. For example, location registration server 300 may transmit a location registration response to enrolled M2M terminal 110 for allowing enrolled M2M terminal 110 to access a corresponding wireless network. Accordingly, enrolled M2M terminal 110 may communicate with M2M managing server 400.

Similarly, upon the receipt of the location registration response, enrolled M2M terminal 110 may perform a program associated with a M2M service at step S419. For example, controller 107 (of, for example, FIG. 2) of enrolled M2M terminal 110 may execute the certain program. Such a program may be stored in memory 109 (of, for example, FIG. 2).

The program may be an application for accessing M2M managing server 400 and controlling wireless access of M2M terminals. For example, the program may operate a timer based on information received from M2M managing server 400. The program may restrict or allow a M2M terminal to access a wireless network until a timer is expired. Such a program may be directly installed at a M2M terminal or downloaded from a related server such as M2M managing server 400 to a M2M terminal through a network. Furthermore, the program may be remotely transmitted to a M2M terminal through a firmware over the air (FOTA).

Unenrolled M2M terminal 120 may transmit an access request to M2M managing server 400 at step S421. Furthermore, enrolled M2M terminal 110 may transmit an access request to M2M managing server 400 at step S423. For example, M2M service access units 113 of unenrolled M2M terminal 120 and enrolled M2M terminal 110 may transmit the access request to M2M managing server 400.

In response to the access request, M2M managing server 400 may search for subscriber information at step S425. Based on the search result, at step S427, M2M managing server 400 may determine whether a M2M terminal sending the access request is an unenrolled or enrolled M2M terminal, such as unenrolled M2M terminal 120 or enrolled M2M terminal 110.

When M2M managing server 400 determines that a M2M terminal sending the access request is unenrolled M2M terminal 120, M2M managing server 400 may transmit inactivation timer information to unenrolled M2M terminal 120 at step S429. The inactivation timer information may include an inactivation timer value. When M2M managing server 400 determines that a M2M terminal sending the access request is enrolled M2M terminal 110, M2M managing server 400 may transmit M2M server access period timer information to enrolled M2M terminal 110 at step S431. For example, the M2M server access period timer information may be a M2M server access period timer value.

Thereafter, unenrolled M2M terminal 120 may drive an inactivation timer based on the inactivation timer information transmitted from M2M managing server 400. Furthermore, enrolled M2M terminal may drive a M2M server access period timer based on the M2M server access period timer information transmitted from M2M managing server 400.

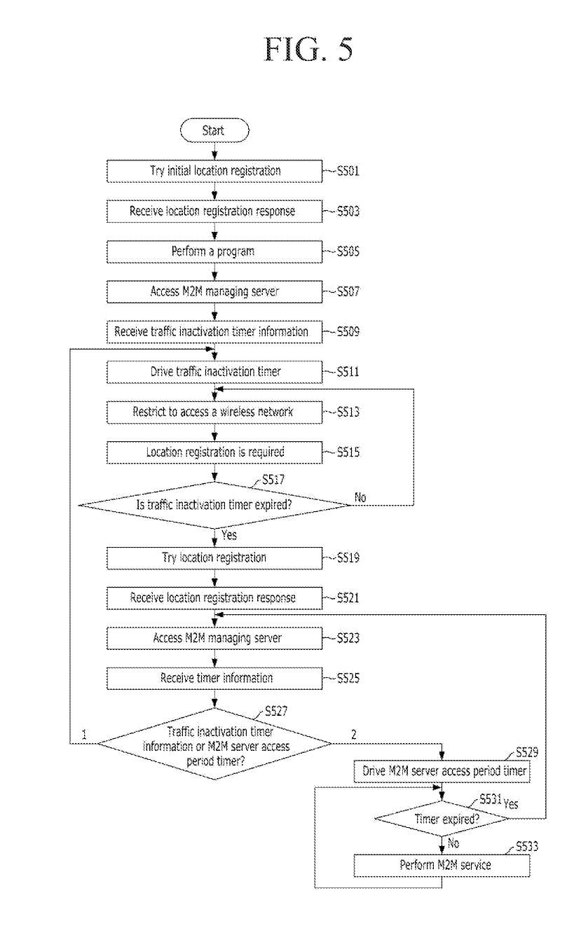

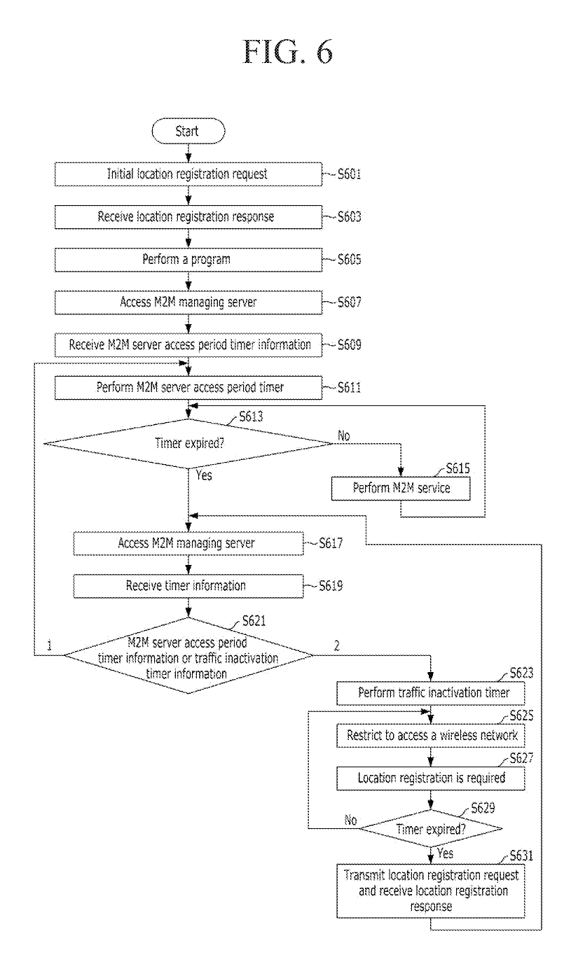

Hereinafter, operation methods of an unenrolled M2M terminal and an enrolled M2M terminal will be described with reference to FIG. 5 and FIG. 6.

FIG. 5 illustrates an operation method of an unenrolled M2M terminal in accordance with an embodiment of the present invention.

Referring to FIG. 5, when unenrolled M2M terminal 120 is powered on, unenrolled M2M terminal 120 may attempt an initial location registration at step S501. For example, location registration unit 103 of unenrolled M2M terminal 120 may transmit a location registration request to location registration server 300.

In response to the location registration request, unenrolled M2M terminal 120 may receive a location registration response from location registration server 300 at step S503. Upon the receipt of the location registration response, unenrolled M2M terminal 120 may be temporally allowed to access a corresponding wireless communication network for a limited time. Unenrolled M2M terminal 120 may carry out a program associated with a M2M service S505. For example, controller 107 of unenrolled M2M terminal 120 may execute the program. The program may be stored in memory 109 or downloaded from M2M managing server 400. As described above, the program may be an application for accessing M2M managing server 400 and operating a timer in order to restrict or allow unenrolled M2M terminal 120 to access a wireless communication network.

Unenrolled M2M terminal 120 may transmit an access request to M2M managing server 400 at step S507. For example, the access request may be transmitted by M2M service access unit 113 of unenrolled M2M terminal 120. Unenrolled M2M terminal 120 may receive inactivation timer information from M2M managing server 400 at step S509. The inactivation timer information may include an inactivation timer value. Based on the received inactivation timer information, unenrolled M2M terminal 120 may set up an inactivation timer and start the inactivation timer at step S511. For example, the inactivation timer may be controlled by controller 107 of unenrolled M2M terminal 120. Controller 107 may set up the inactivation timer based on the received inactivation timer value and start the inactivation timer.

Unenrolled M2M terminal 120 may be restricted to access a wireless network until the inactivation timer expires at step S513. For example, blocking unit 111 may interrupt location registration unit 103 to perform location registration and/or restrict unenrolled M2M terminal to access a wireless network until the inactivation timer expires.

After interrupting the location registration, an event requiring location registration may be generated at step S515. For example, location registration may be required when a location area code (LAC) is changed or when a location registration period is arrived. In this case, blocking unit 111 may again determine whether an inactivation timer is expired at step S517. When the blocking unit 111 determines that the inactivation timer is not expired (No-S517), the blocking unit 111 may continue to restrict unenrolled M2M terminal to access a wireless network at step S513.

When the blocking unit 111 determines that the inactivation timer is expired (Yes-S217), blocking unit 111 may request location registration unit 103 to attempt location registration at step S519. For example, location registration unit 103 may transmit a location registration request to location registration server 300.

In response to the location registration request, unenrolled M2M terminal 120 may receive a location registration response from location registration server 300 at step S521. That is, unenrolled M2M terminal 120 may be allowed to access a corresponding wireless communication network for a limited time. Unenrolled M2M terminal 120 may transmit an access request to M2M managing server 400 at step S523. In response to the access request, unenrolled M2M terminal 120 may receive timer information from M2M managing server 400 according to an enrollment status of unenrolled M2M terminal 120 at step S525.

The enrollment status of unenrolled M2M terminal 120 may be changed when unenrolled M2M terminal 120 enrolls for a M2M service. If the enrollment status of unenrolled M2M terminal 120 changed, unenrolled M2M terminal 120 may change status to an enrolled M2M terminal. In this case, M2M terminal 120 may receive M2M server access period timer information from M2M managing server 400. Otherwise, M2M terminal 120 may receive inactivation timer information again from M2M managing server 400.

Accordingly, controller 107 of unenrolled M2M terminal 120 may determine whether the received timer information is inactivation timer information or M2M server access period timer information at step S527. When controller 107 determines that the received timer information is the inactivation timer information (1-S527), controller 107 may set up an inactivation timer based on the received inactivation timer information and start the inactivation timer again at step S511.

When controller 107 determines that the received timer information is the M2M server access period timer information (2-S527), controller 107 may set up a M2M service access timer based on the M2M server access period timer information and start the M2M service access timer at step S529. Accordingly, unenrolled M2M terminal 120 may start operating as an enrolled M2M terminal.

While the M2M server access period timer is not expired (No-S531), M2M terminal 120 may perform a M2M service at step S533. When the M2M server access period timer is expired (Yes-S531), M2M terminal 120 may access M2M managing server at step S523 and receive timer information from M2M managing server again at step S525.

As described above, unenrolled M2M terminal 120 may be temporally allowed to access a wireless communication network for a limited time and interrupted to try location registration until the inactivation tinier is expired. Accordingly, unnecessary location registration trail may be prevented in accordance with an exemplary embodiment of the present invention.

FIG. 6 illustrates an operation method of an enrolled M2M terminal in accordance with an exemplary embodiment of the present invention.

Referring to FIG. 6, when enrolled M2M terminal 110 is turned on, enrolled M2M terminal 110 may try initial location registration at step S601. Enrolled M2M terminal 110 may receive a location registration response from location registration server 300 at step S603. Controller 107 of enrolled M2M terminal 110 may carry out a program associated with a M2M service at step S605.

M2M service access unit 113 of enrolled M2M terminal 110 may access M2M managing server 400 at step S607.

Receiver 105 of enrolled M2M terminal 110 may receive M2M server access period timer information from the M2M managing server 400 at step S609. Controller 107 may set up a M2M server access period timer based on the received M2M server access period timer information and start the M2M server access period timer at step S611.

Enrolled M2M terminal 110 may perform the M2M service at step S615 until the M2M server access period timer expires (No-S613). When M2M service access unit 113 of enrolled M2M terminal 110 determines the M2M server access period timer is expired at step S613 (Yes-S613), M2M server access unit 113 may access M2M managing server 400 at step S617 and receive timer information at step S619. As described above, an enrollment status of enrolled M2M terminal 110 may change. The enrollment status of enrolled M2M terminal 120 may be changed when enrolled M2M terminal 110 cancels or otherwise terminates a M2M service. If the enrollment status of enrolled M2M terminal 110 changes, status of enrolled M2M terminal 110 may change to an unenrolled M2M terminal.

Accordingly, controller 107 of enrolled M2M terminal 110 may determine, at step S621, whether the received timer information is the M2M server access period timer information or the inactivation timer information. When the received timer information is the M2M server access period timer information (1-S621), controller 107 may set up the M2M server access period timer based on the received M2M server access period timer information and start the M2M server access period timer again at step S611.

When the received timer information is the inactivation timer information (2-S621), controller 107 may set up an inactivation timer based on the received inactivation timer information and start the inactivation timer at step S623. Blocking unit 111 may suspend or restrict access to a wireless communication network at step S625.

Thereafter, an event requiring location registration may be generated at step S627. In this case, blocking unit 111 may determine whether the inactivation timer is expired at step S629. When blocking unit 111 determines that the inactivation timer is not expired (No-S629), blocking unit 111 may continue to restrict access to a wireless communication network at step S625. Accordingly, M2M terminal 110 may be restricted to attempt location registration.

When blocking unit 111 determines that the inactivation timer is expired (Yes-S629), blocking unit 111 may allow location registration unit 103 to attempt location registration. Accordingly, a location registration request may be transmitted to location registration server 300 and a location registration response may be received from location registration server 300 at step S631. Upon the receipt of the location registration response, M2M terminal 110 may access M2M managing server 400 again at step S617 and receive timer information from M2M managing server 400 at step S619.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation,”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manlier specified by the standard. The compatible element does not need to operate internally in a manner specified by the standard.

No claim element herein is to be construed under the provisions of 35 U.S.C. 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A machine to machine (M2M) service providing system comprising:
a location registration server configured to receive a location registration request from a M2M terminal and transmit a location registration response to the at least one M2M terminal, thereby allowing the at least one M2M terminal to access a mobile communication network; and
a M2M managing server configured to provide one of inactivation tinier information and M2M server access period timer information to the M2M terminal according to a M2M service enrollment status of the M2M terminal.

2. The M2M service providing system of claim 1, wherein:
the M2M terminal includes a universal subscriber identity module (USIM) card, the M2M terminal unregistered with the mobile communication network; and
the location registration unit transmits a location registration response to the M2M terminal, thereby allowing access to the mobile communication network for a given time.

3. The M2M service providing system of claim 1, wherein:
the M2M service enrollment status of the M2M terminal is unenrolled for a M2M service;
the location registration unit transmits a location registration response to the M2M terminal, thereby allowing accessing the mobile communication network for a given time; and
the M2M terminal accesses the M2M managing server for the given time and receives the inactivation timer information from the M2M managing server.

4. The M2M service providing system of claim 3, wherein:
the M2M terminal enables an inactivation timer based on the inactivation timer information and restricts access to the mobile communication network until the inactivation timer expires.

5. The M2M service providing system of claim 3, wherein:
the M2M terminal initiates an inactivation timer based on the inactivation timer information and restricts transmission of the location registration request to the location registration server until the inactivation timer expires.

6. The M2M service providing system of claim 1, wherein the inactivation timer information includes an inactivation timer value.

7. The M2M service providing system of claim 1, wherein:
the M2M service enrollment status of the M2M terminal is enrolled for a M2M service; and
the M2M managing server provides the M2M server access period timer information to the M2M terminal.

8. The M2M service providing system of claim 7, wherein:
the M2M terminal sets up a M2M server access period timer based on the M2M server access period timer information; and
the M2M terminal is allowed to access the mobile communication network until the M2M server access period timer is expired.

9. The M2M service providing system of claim 8, wherein:
the M2M terminal receives the M2M service until the M2M server access period timer expires.

10. The M2M service providing system of claim 8, wherein:
the M2M managing server determines whether the at least one M2M terminal is enrolled for the M2M service after the M2M server access period timer expires.

11. The M2M service providing system of claim 1, wherein the M2M server access period tinier information includes a M2M server access period timer value.

12. The M2M service providing system of claim 1, wherein the inactivation tinier information and the M2M server access period timer information are initiated based on a type of at least one M2M terminal, a type of the M2M service, and a status of the mobile communication network.

13. A method for providing a machine to machine (M2M) service to a M2M terminal, the method comprising:
transmitting a location registration response in response to a location registration request for allowing the M2M terminal to access a mobile communication network; and
providing at least one of inactivation timer information and M2M server access period timer information to the M2M terminal according to a M2M service enrollment status of the M2M terminal.

14. The method of claim 13, wherein in the transmitting a location registration response:
temporarily allowing the M2M terminal to access the mobile communication network for a given time when the M2M terminal has a universal subscriber identity module (USIM) card unregistered with the mobile communication network.

15. The method of claim 13, wherein in the transmitting a location registration response:
temporarily allowing the M2M terminal to access the mobile communication network for a given time when the M2M terminal is not enrolled for a M2M service.

16. The method of claim 13, further comprising, prior to providing at east one of inactivation timer information and M2M server access period timer information:
determining whether the M2M terminal is enrolled for a M2M service based on subscribing information stored in a database.

17. The method of claim 16, further comprising:
providing the inactivation timer information to the M2M terminal when the M2M service enrollment status of the M2M terminal is determined as unenrolled for the M2M service;
initiating an inactivation timer based on the inactivation timer information; and
restricting access of the M2M terminal to the mobile communication network until the inactivation timer expires.

18. The method of claim 17, wherein the restricting access of the M2M terminal includes:
restricting transmission by the M2M terminal of a location registration request until the inactivation timer expires.

19. The method of claim 16, further comprising:
providing the M2M server access period timer information to the M2M terminal when the M2M service enrollment status of the M2M terminal is determined as enrolled for the M2M service;
initiating an M2M server access period timer based on the M2M server access period timer information; and
allowing reception by the M2M terminal of the M2M service until the M2M server access period timer expires.

20. The method of claim 19, further comprising:
repeating determining whether the M2M service enrollment status of the M2M terminal is enrolled for the M2M service after the M2M server access period timer expires.
